(19) United States
(12) Patent Application Publication
(10) Pub. No.: US 2015/0107069 A1
(43) Pub. Date: Apr. 23, 2015

(54) METHOD FOR END MACHINING AND MACHINE FOR THE METHOD

(71) Applicant: MAG IAS GMBH, Göppingen (DE)

(72) Inventors: Matthias Geiger, Hattenhafen (DE); Robert Räder, Goppingen (DE); Werner Mühlich, Sussen (DE); Wolfgang Hafner, Sussen (DE)

(73) Assignee: MAG ISA GMBH, Goppingen (DE)

(21) Appl. No.: 14/386,715

(22) PCT Filed: Mar. 22, 2013
(86) PCT No.: PCT/EP2013/056062

§ 371 Date: Nov. 25, 2014

(30) Foreign Application Priority Data
Mar. 23, 2012 (DE) 102012102499.5

(51) Int. Cl. G01M 1/24

(52) U.S. Cl. CPC G01M 1/24
USPC 29/6.01; 29/888.08

(57) ABSTRACT

In order to prevent a subsequent imbalance of a finished crank shaft a work piece is rotated about an A-axis and a B-axis before introducing aligned centering bore holes (balanced centering) according to the invention instead of transversally offsetting the centering bore holes (geometric balancing) which is known in the art.

### I. FIELD OF THE INVENTION

The invention relates to end machining of work pieces with centric, rotation symmetrical surfaces like e.g. crank shafts, including introducing centering bore holes into end faces of the work piece.

### II. BACKGROUND OF THE INVENTION

When producing crank shafts a blank that is produced as a cast or forged component is machined at one end, the so called pinion and at the other end the so called flange, since clamping devices are used at the machined end portions during the subsequent machining steps of the main portion of the work piece.

During end machining the work piece on the one hand side has to be brought to the correct length, the round outer circumference of flange and pinion has to be machined and a respective centering bore hole has to be introduced into the end faces, wherein the centering bore hole is used for supporting the crank shaft in the machine through the centering tip received therein depending on the machining step on one side of the crank shaft, optionally together with a back rest.

Thus, the problem is that the blanks do not always have exactly the same shape but differ due to increasing wear of the casting or forging mold with respect to more or less pronounced burrs and other deviations during master forming.

Some work pieces, among them also crank shafts, however, are subsequently not machined along their entire surface but portions remain that are not machined, e.g. at the lobes towards the lift bearings and back. Therefore deviations of the blank influence whether the machined work piece has an imbalance and how big the imbalance is and in which direction the imbalance is oriented.

It is certainly attempted during machining to remove the imbalance by introducing balance bore holes or balance cutouts into circumferential portions of the work piece that do not serve any particular function in order to balance the work piece.

For a larger provided imbalance the available surfaces, however, often do not suffice to arrange the required number of balancing bore holes.

Since the blanks of a batch typically are very similar it is known after machining the first work pieces of a batch how strong and in which direction a blank and thus the machined crank shaft will be imbalanced and attempts are being made to compensate the imbalance right from the beginning by taking it into consideration when initially machining the ends of the crank shaft.

End machining is therefore typically done so far in that the crank shaft blank is clamped in a moveable vise in a machining center so that the end portions to be machined are accessible. In this clamped fixation with a stationary, thus non rotating crank shaft, the blank is brought to a correct axial length e.g. through driven pot shaped cutters by moving the cutters transversal to the blank and subsequently the centering bore hole is produced by axially moving the pot shaped rotating cutter which carries a centering drill bit in its center over the respective end portion. The inner diameter of the cutter is thus greater than the outer diameter of the end portion of the work piece.

Subsequently another pot shaped cutter whose inner diameter corresponds to the outer diameter of the end portion is machined through axial overlapping.

Simultaneously or through a cutting tool also the centering bore hole is introduced into the end face of the end portion.

For the purposes of the present invention thus the axial orientation of the work piece or of the moveable vise is defined as a Z-direction for the work piece and more precisely the direction in which the centering bore holes are introduced.

The driven cutting tools are thus moveable in X-direction and in Y-direction along the bed of the machine along which also the moveable vise for the work piece is attached.

In order to minimize the imbalance detected in the first work pieces of a batch the two centering bore holes are not introduced on the same Z-axis but only in opposite directions into the work piece but one of the driven tools is slightly offset in X-direction and/or in Y-direction relative to the respective tool at the other end of the work piece, so that the expected imbalance is compensated.

The centering bore holes and in particular for a common cutting tool including a centering drill and enveloping pot shaped cutter, are introduced in Z-direction relative to ends to be machined not in two aligned Z-directions, but in opposite Z-directions that are offset parallel to one another.

This so called geometric centering, however, has the disadvantage that the work piece is not supported with optimum stability between the tips during subsequent clamping of the crank shaft but the work piece can have a slight eccentricity, since during the subsequent machining steps the two centering tips receiving the work piece are on a common aligned centering axis, the Z-axis but the orientations of the two centering bore holes in the work piece are not arranged on a common and aligned centering bore hole axis.

### III. SUMMARY OF THE INVENTION

### a) Technical Object

Thus, it is the object of the invention to provide a method which overcomes the disadvantages of the known method and to provide a suitable machine which performs the method in a less complex manner and which is not more expensive than the machines used so far.

### b) Solution

This object is achieved through the features of the claims 1 and 8. Advantageous embodiments can be derived from the dependent claims. The method according to the invention includes introducing the aligned centering bore holes on the same Z-axis only oriented opposite to one another in order to compensate the imbalance but to previously pivot the work piece about the A- and/or B-axis so that the expected imbalance without the pivoting is provided in this condition or better of the finished work piece is minimized which is subsequently designated as balance centering.

For this purpose it is being determined what the size and the radial orientation of the machined first work pieces of a batch is and accordingly the size and the orientation of the work piece about the A-axis and the B-axis is determined. A rotation of the work piece about its C-axis which would then facilitate an additional rotation of the work piece only either about the A-axis or the B-axis is typically not possible since the blank is received in the moveable vise in a particular position about the C-axis that is determined through form locking in the moveable vise.

This yields the advantage that the introduced centering bore holes are aligned with one another so that the work piece is supported in an optimum manner during subsequent machining steps and supported between centering tips in the centering bore holes, since the orientation of the centering tips coincides with the orientation of the centering bore holes.

Thus pivoting about an axis can be achieved in different ways.

In the simplest case a pivot pin suffices about which the work piece is pivotable in particular together with the moveable vice supporting the work piece.

Thus, for example a pivot pin for the moveable vice that protrudes in X-direction can be additionally moveable in Y-direction in order to omit the Y-movement of the tool units.

Another option is for example to implement a pivoting about the V-axis in that the moveable vice supporting the work piece is moved by different amounts onto Y-supports offset in Z-direction.

In order to perform the method according to the invention a machine is proposed in which the moveable vice with the work piece received therein is pivotable about the A-axis and/or about the B-axis relative to the bed of the machine.

Certainly the pivotability like all other processes of the machine is caused by a machine control into which either the amount of pivoting about the A-axis and/or the B-axis is entered directly or into which only the size and direction of the imbalance at the preceding work pieces has to be entered and which determines the amount of pivoting of the moveable vice about the A-axis and/or the B-axis itself.

The pivotability about these axes, for example the A-axis can be theoretically implemented differently for example in that the moveable vice is pivotable about the solid support pin that is oriented in a direction of the X-axis.

However since substantial forces impact the work piece supported in the moveable vice the moveable vice is supported additionally or instead on Y-supports oriented in Y-direction and offset in C-direction.

A pivoting about the A-axis is then feasible either about the pivot pin that is additionally provided in particular arranged in the axial center of the moveable vice or simply in that separately controlled drives are provided for moving the moveable vice respectively along one of the two Y-supports and the movement in Y-direction is sized differently so that a slanting of the moveable vice is achieved relative the C-axis analogous to the rotation of the A-axis.

Then however a rotatability of the moveable vice on the support slides that support it on the Y-supports is required as well as a movability in longitudinal direction Z at least relative to at least one of the slide bases since a distance of the slide bases changes for each slanting.

In case no pivot pin is provided the moveable vice is rotatable relative to one of the slide bases but not moveable in longitudinal direction. The length compensation is only performed relative to the other slide base during pivoting. Also when the moveable vice is moved with separate drives along the two Y-supports the moveable vice can also be moved relative to the Z-axis of the machine about the A-axis.

Analogously the pivoting about the B-axis can be achieved.

An implementation of the Y-axis in the moveable vice then however facilitates the omitting of the Y-slide for both tool supports of the machine which then, however, are much more complex because the X-slides of the support have to run on the Y-slides.

The savings at the machine through tool supports which only include an X-slide are thus higher than the additional complexity for implementing the Y-movement at the moveable vice.

The pivotability of the moveable vice about the B-axis can also be implemented in different ways and also here offset X-supports that extend in X-direction can be used which may be arranged on the support slides, wherein the moveable vice can be moved in X-axis and which pivotability among other things is used for pivoting the moveable vice about the B-axis analogous to pivoting it about the A-axis with or without the pivot pin being provided.

Since longitudinal movements in X-direction and in Y-direction are typically only performed in the one tenth mm range for the purpose of pivoting it is typically not useful to also move the method for implementing the X-axis from the tool supports into the movability of the movable vice. This will only be useful in exceptional situations.

### c) Embodiments

Embodiments according to the invention are subsequently described in more detail with reference to drawing figures, wherein:

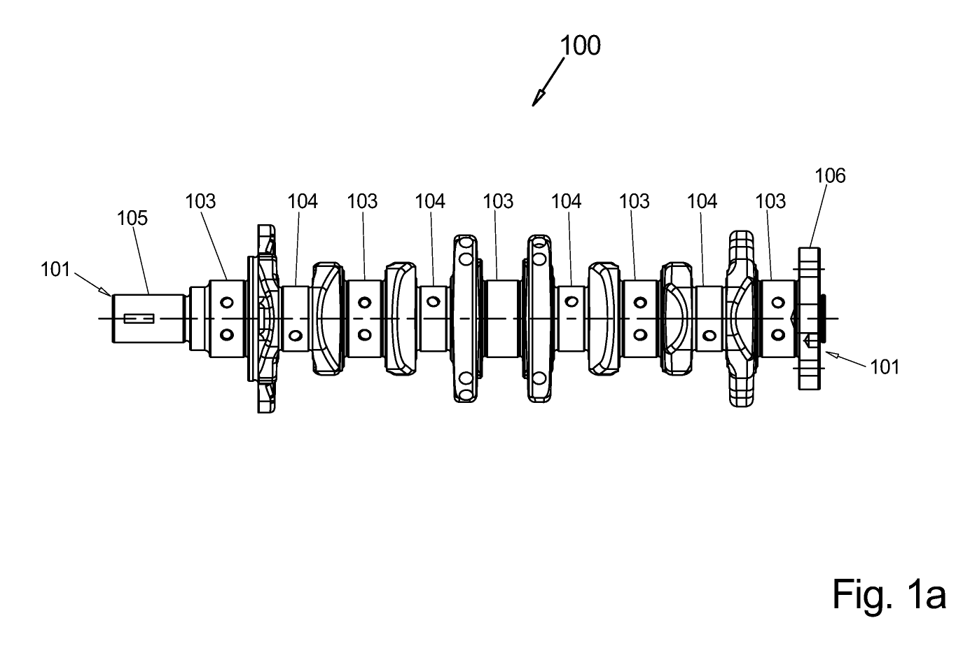

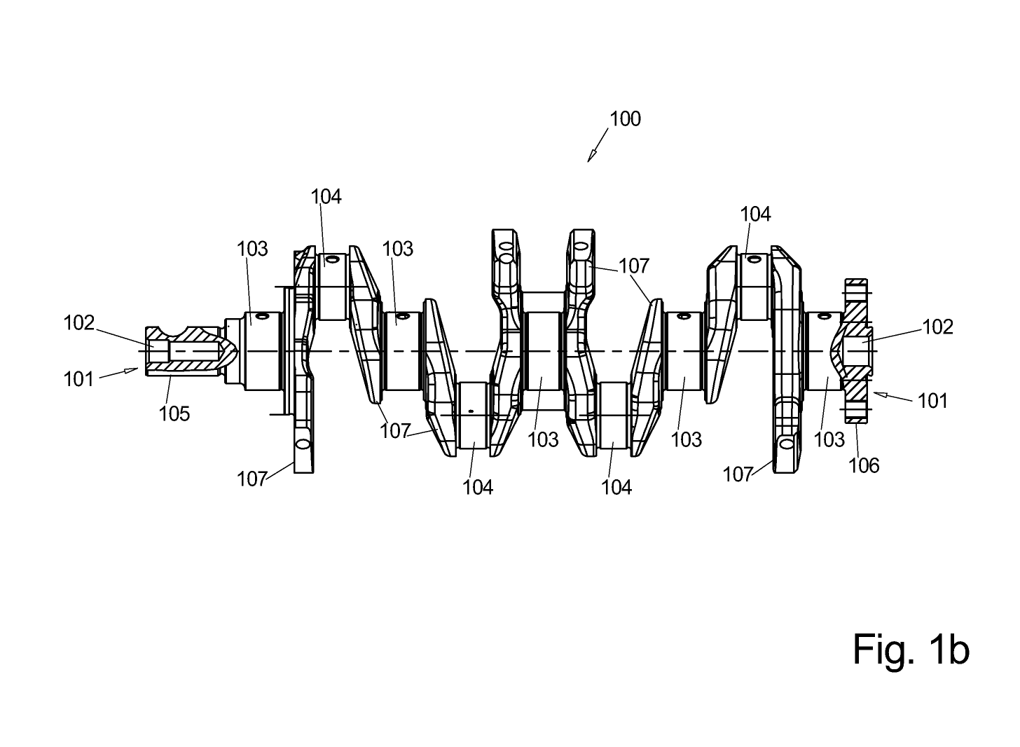

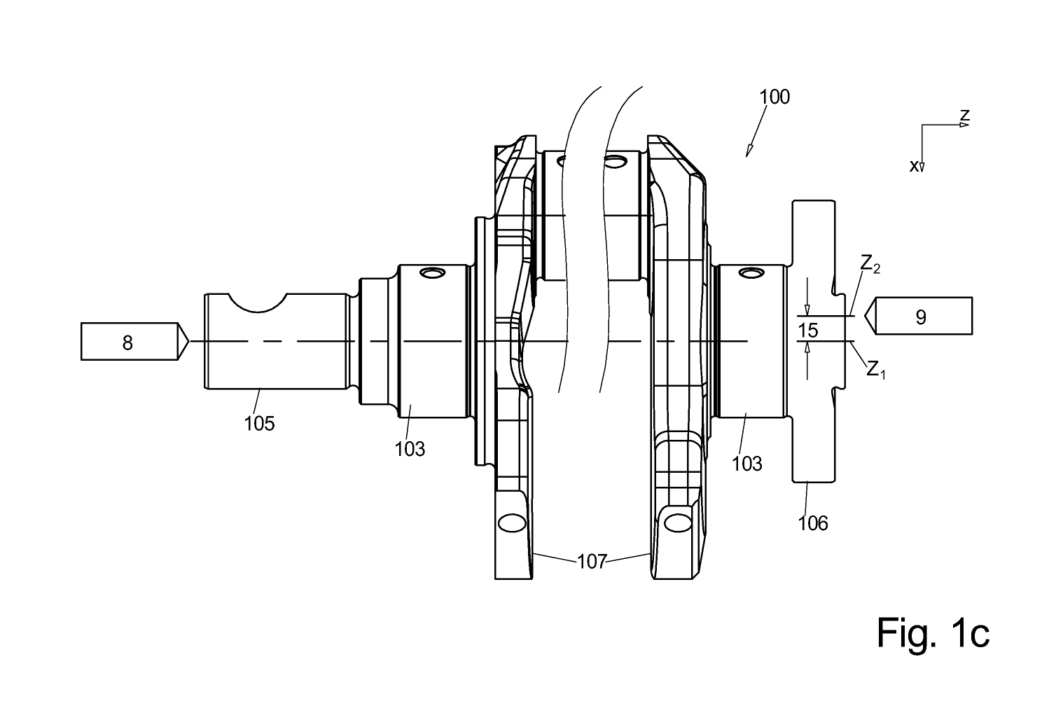

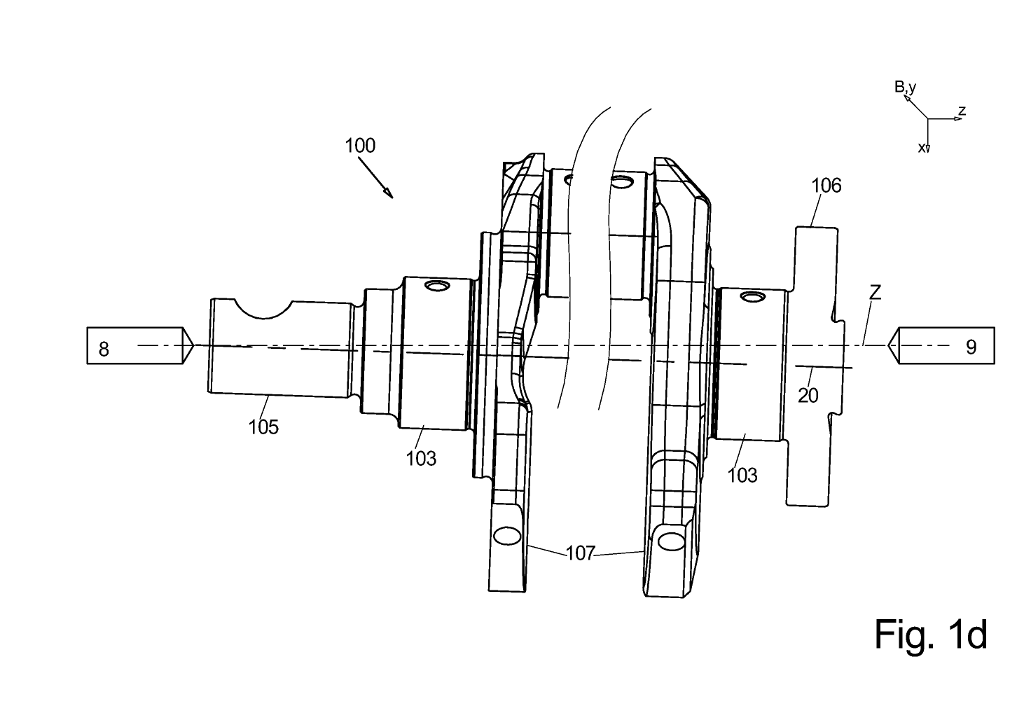

FIG. 1a, b: illustrates a crank shaft configured as a work piece with machined ends;

FIG. 1c: illustrates end machining known in the art;

FIG. 1d: illustrates end machining according to the invention;

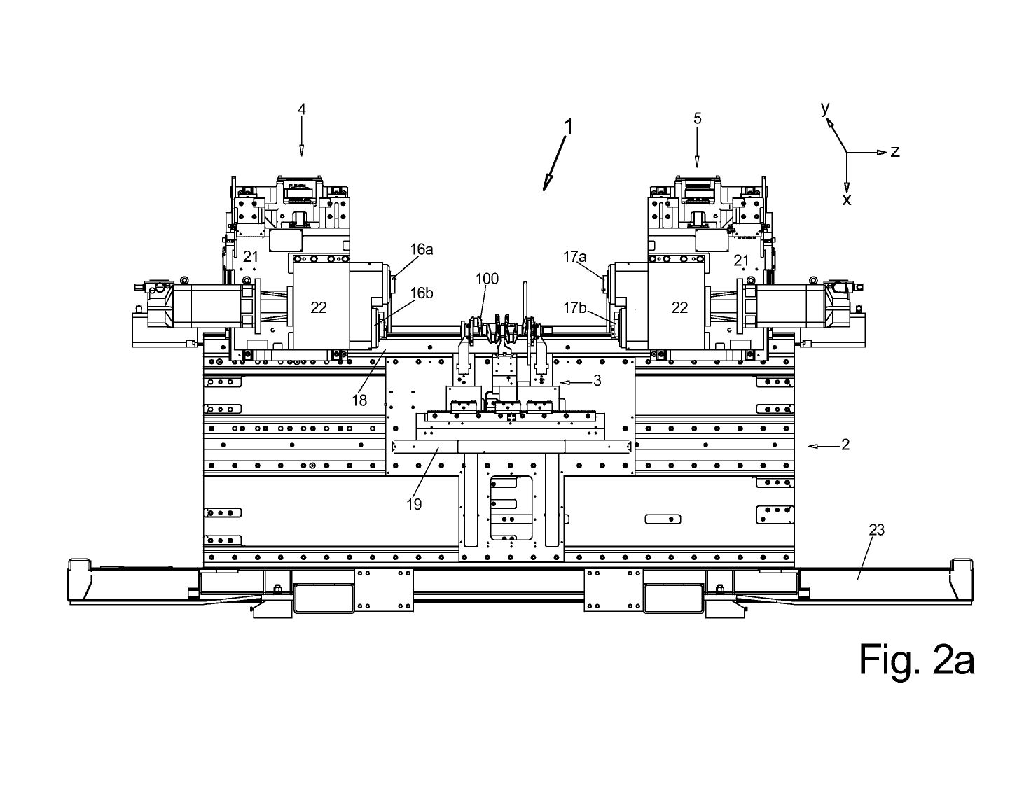

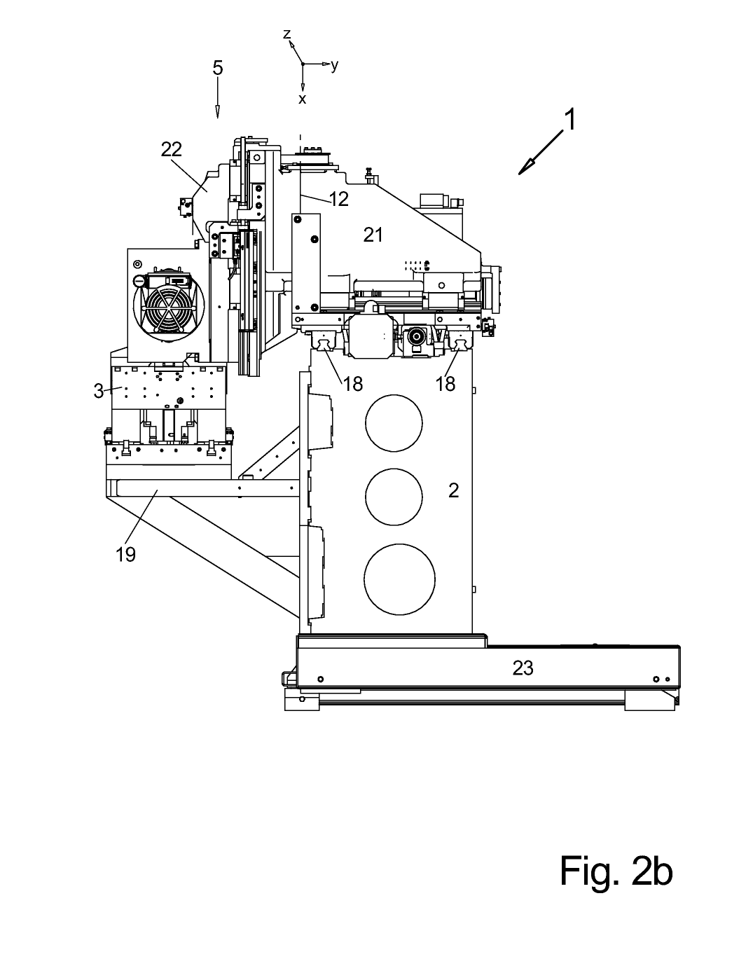

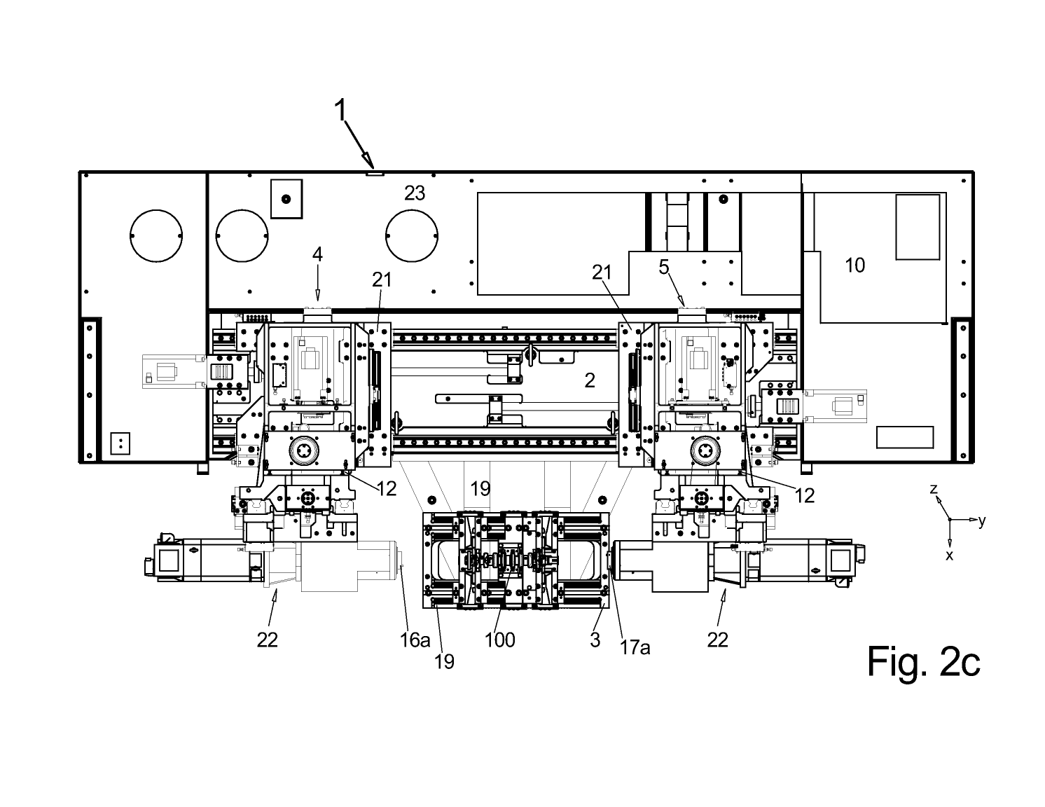

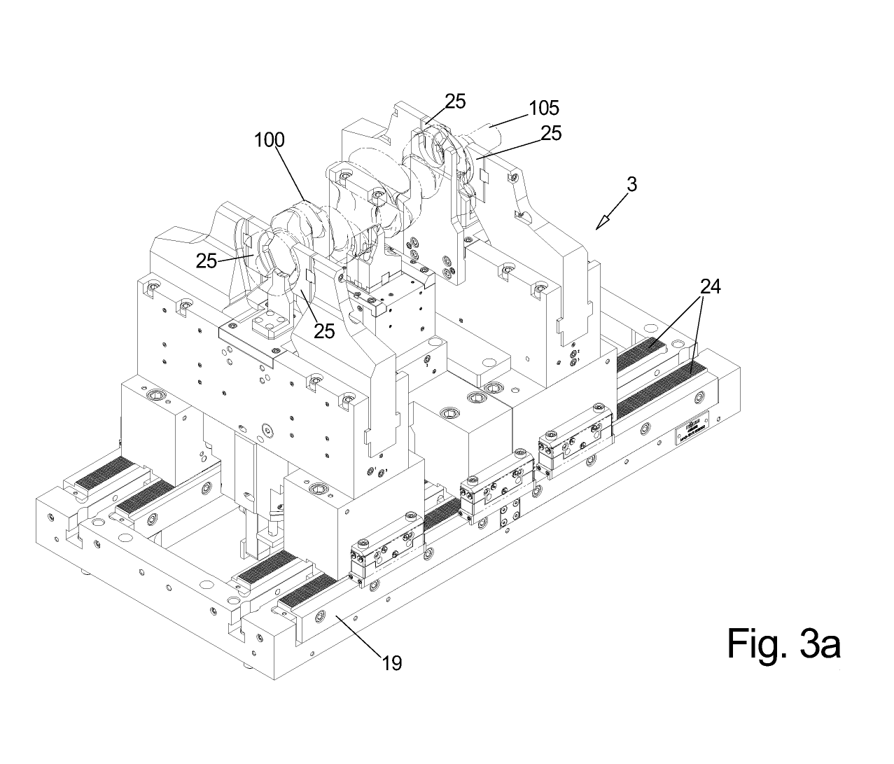

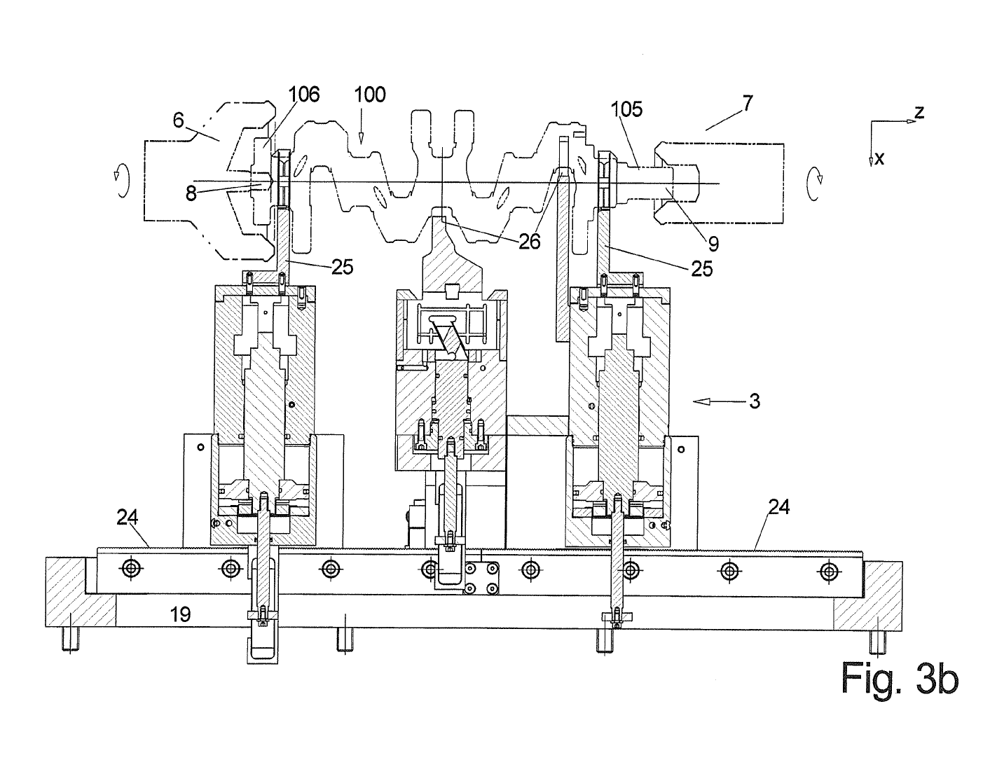

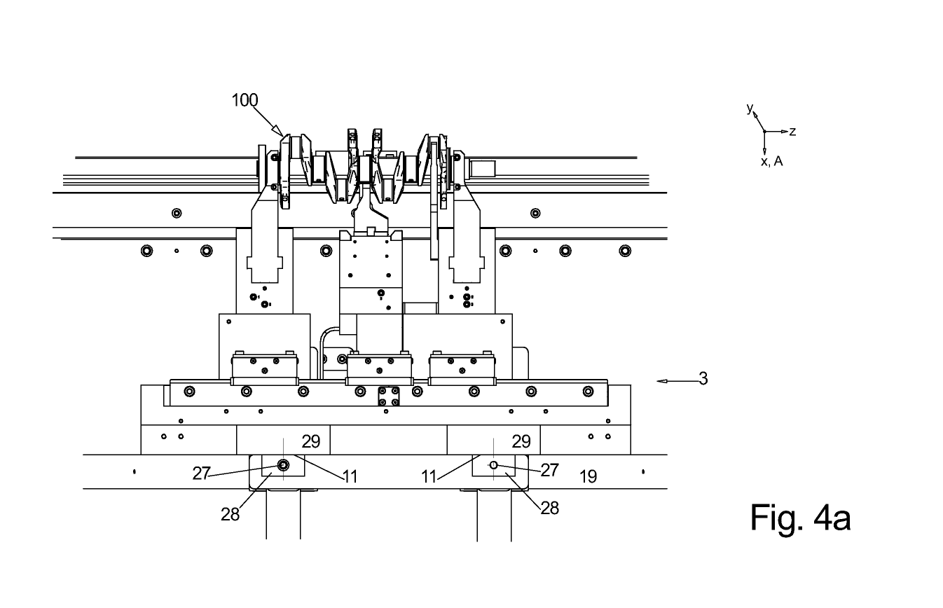

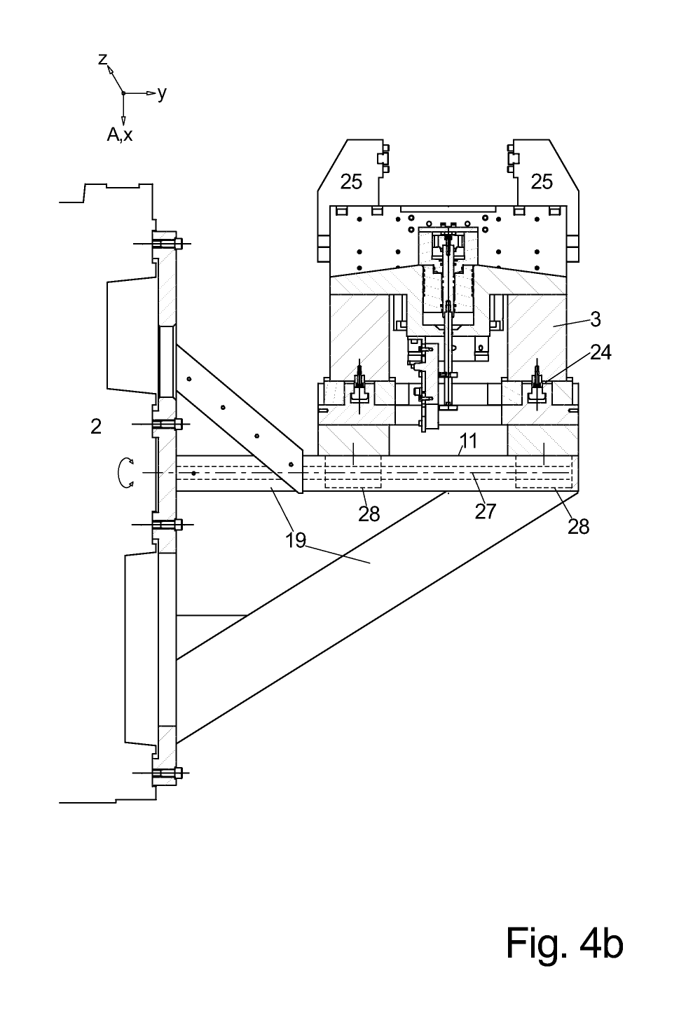

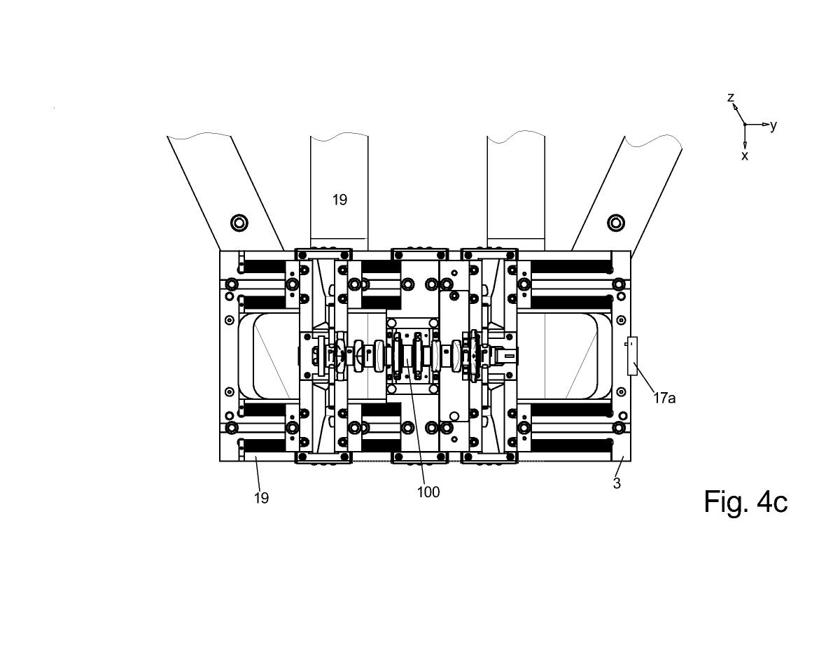

FIG. 2a-c: illustrates the machine according to the invention; FIG. 3a, b: illustrates the moveable vice for the work piece separately; and FIG. 4a-c: illustrates the moveable vice at the bed of the machine.

FIG. 1a, b illustrates a crank shaft as a typical work piece 100 at which end machining according to the invention shall be performed by machining an enveloping surface in end portions of the crank shaft 100, namely the so called pinion 100 at one end on the one hand side and the disc shaped flange 106 at the other side, wherein the crank shaft is brought to the correct length and a centering bore hole 102 is respectively introduced into the faces of pinion 105 and flange 106 as apparent from the side view of the crank shaft in FIG. 1b.

In this side view furthermore the stroke of the crank shaft 100 is clearly evident wherein the stroke bearings 104 are eccentrically offset relative to the center bearings 103 respectively connected through the lobes 107.

The remaining visible details like oil bore holes etc. are less relevant for the present invention.

FIGS. 2a-c illustrate a machine tool 1 in a frontal view, axial view and top view wherein a crank shaft 100 or another similar work piece that is provided as a forged or cast blank is machined in the end portions wherein the end portions are used in subsequent machining steps for precisely clamping the work piece 100 during machining of the center portion.

The machine 1 is associated with the category of machining centers since the work piece 100 is thus machined in non rotating condition through rotating tools 6, 7.

For this purpose a moveable vise table 19 is attached at a front side of a bed 2 of the machine 1 wherein the bed has a substantially cuboid upright basic shape and rests on a larger base plate 23 wherein the moveable vise table protrudes forward from the front side of the bed 2 and has the moveable vise 3 mounted thereon which is specifically adapted to the respective work piece 100 to be machined, in this case a particular crank shaft and is accordingly positioned on the moveable vise table 19. The adaptation is provided in particular in that the moveable vise has clamping jaws 25 for the work piece 100 which are visible better in FIGS. 3a, b.

Two tool units 4, 5 run on the top side of the bed 2 wherein Z-supports 18 extend on the top side wherein the respective Z-slide 21 of the tool unit is moveable along the Z-supports.

Herein the Z-direction is the connecting line between the two tool units 4, 5 and thus defines approximately the axial direction of the work piece 100 to be machined.

At the front surface of the Z-slide 21 an X-slide is moveable along X-supports 12 thus vertically relative to the moveable vise 3 so that the work piece 100 is moveable to and from the Z-slide 21. Each X-slide 22 supports a tool in this case inserted therein which can be driven to rotate about the Z-axis in addition to a tool spindle 16a, b or 17a, b supported by each X-slide 22.

The positioning of the tools 6, 7 relative to the work piece 100 in Y-direction can be provided in that a respective Y-slide that is moveable on the Z-slide in Y-direction is provided for the tool units 4, 5 between the Z-slide and the X-slide. Preferably the adjustment is performed however according to the invention in Y-direction on the side of the moveable vise 3 as described with reference to FIGS. 4a-c.

The entire machining performed on this machine is controlled by a central machine control 10 like in all machine tools.

As illustrated in the enlarged depiction of the moveable vise 3, in a perspective view and a front view of the FIGS. 3a, b the moveable vise 3 on the one hand side includes two pairs of clamping jaws 25 which clamp the work piece in this case the crank shaft 100 respectively at the respective last main bearing 103 between one another. Additionally the moveable vise 3 includes a support bearing 26 in its center wherein another main bearing 103 of the crank shaft 100 can be supported in the support 26.

The positioning of the crank shaft 100 thus provided is a coarse positioning since the surfaces at which the clamping jaws 25 and the support bearing 26 contact the crank shaft 100 are not machined yet at this point in time.

The three units which support on the one hand side the two clamping jaws 25 and on the other hand side the support 26 are moveable in Z-direction along gear racks 24 which are arranged on the top side of the moveable vise 3 table 19 and are in particular clampable in a form locking manner and also have adaptability in Y-direction and through selecting the right size of clamping jaws 25 and supports 26 and/or through adjustability in X-direction have an alignment capability in X-direction.

FIG. 3b illustrates machining the flange 106 and the pinion 105 respectively through rotating tools 6, 7.

The first tool 6 that is being used is being illustrated at the end portion 106. This is a pot shaped rotating tool 6 configured as a pot-cutter in whose center a centering drill 8 is arranged, wherein the centering drill is moved backward relative to the front of the pot. The inner diameter of the pot is greater than the outer diameter of the end portion. Initially the work piece 100 is cut to length through transversal movement through the cutting edges of the pot, thus the face is being milled. Thereafter the centering bore hole 102 is introduced through the centering drill 8 through overlapping this tool.

In the next process step an enveloping surface of the respective end portion, for example of the pinion 105 is machined through another pot shaped rotating tool 7 as illustrated at a right end of the work piece 100 at the pinion 105 and whose inner diameter corresponds to an outer diameter of the respective end portion of the work piece 100 that is to be machined, wherein the machining is done through overlapping the head over the end portion, e.g. the pinion 105 through the inside of the pot shaped rotating tool 7.

As a matter of consequence the dimensions of the tool have to be accordingly adapted to the contours that are to be produced at the work piece.

FIGS. 1c and 1d illustrate the end portions of a crank shaft 100 that are to be machined, wherein FIG. 1c illustrates a type of machining that is known in the art and FIG. 1d illustrates a machining according to the present invention.

FIGS. 1c and d respectively illustrate the work piece in the Z-X plane.

When it becomes evident that the finished work pieces 100 of a batch have an imbalance in the form of excess weight in the illustration in FIGS. 1c, d, e.g. in the right upper portion of the work piece 100, this was compensated in the art at the subsequent work pieces in that the right centering bore hole 102 to be introduced with the centering drill 9 was slightly offset upward by the distance 15 and so that also the respective enveloping surface of the work piece was moved upward.

With reference to the connection line between the two centering bore holes 102 the imbalance in the Z-X plane was less, but the centering bore holes 102 were not in alignment with one another anymore since they were now arranged on parallel and offset Z-axes Z1 and Z2, which caused subsequent manufacturing imprecisions during subsequent reception between aligned tips in the next process step and non optimum clamping of the work piece.

In the same manner also an imbalance arranged in the Y-Z-plane was minimized by moving the centering bore hole 102 in Y-direction.

The problem of centering bore holes 102 that are not in alignment with one another is prevented according to the invention, see FIG. 1d in that the centering drills 8, 9 are always on a common aligned Z-axis Z.

In order to minimize an imbalance in the X-Z- plane illustrated in FIG. 1d the work piece 100 is instead slightly pivoted about the B-axis wherein the center of gravity can be in a center of a longitudinal extension of the work piece or also at or proximal to one of its end portions, advantageously opposite to the position of the imbalance to be eliminated.

In FIG. 1d an impact point of the left centering drill 8 on the left end face at the pinion 105 of the crank shaft 100 is selected as a pivot point.

Frequently a pivoting of the work piece 100 about the A-axis is additionally required for analogously minimizing an imbalance also in the Y-Z-plane.

Thus the pivot angles as well as the distance 15 in FIG. 1c are illustrated highly exaggerated since in reality these are pivot angles of typically less than 1°.

FIGS. 4a, b, c illustrated in which way a respective alignment of the work piece 100 in the machine tool 1 is performed.

For this purpose the moveable vise and therewith the crank shaft 100 that is received in a form locking manner is slightly tiltable relative to the moveable vise table 19 about the A-axis.

This is performed in this case in that two threaded spindles 27 extend in the moveable vise table 19 in Y-direction and are offset in Z-direction on which spindles a respective spindle nut 28 or two spindle nuts 28 offset in Y-direction are supported so that they so not co rotate with the threaded spindle 27 but are axially moved by the threaded spindle 27.

The moveable vise 3 sits on the spindle nuts 28 with its bottom side for example through a respective support block 29 and is fixated at the spindle nuts 28 but pivotable within limits about the A-axis.

On one side of the moveable vise 3, for example in FIG. 4a the right side, the support block 29 of the moveable vise 3 has to be additionally moveable within limits also in the Z-direction relative to the spindle nut 28, since a slanting of the moveable vise 3 relative to the Z-direction of the bed 2 of the machine changes a distance between two spindle nuts 28 offset in Z-direction.

Instead of the spindle nuts and the threaded spindles also longitudinal supports with support bases running thereon are useable, wherein a drive along the longitudinal supports then has to be additionally implemented.

The moveable vise 3 can thus be pivoted by a desired angle about the axis A relative to the Z-axis of the bed 2 of the machine 1.

Synchronous movement of the threaded spindles 27 facilitates moving the moveable vise 3 also parallel to the Z-direction in this case horizontally so that the Y-axis of the machine can be completely implemented through the moveable vise 3 so that the tool units 4, 5 do not require a Y-slide.

When a balancing in the X-Z-plane is additionally required an elevation adjustment is provided e.g. in the base elements of the clamping jaws 25 as best apparent in FIG. 3b wherein the elevation adjustment can be independently controlled for both clamping jaws 25 so that the axial direction of the crank shaft 100 can be brought into the desired slant angle relative to the Z-direction of the machine tool in the Z-X plane.

Also a rotation of the moveable vise table 19 relative to the bed 2 of the machine about the B-axis can have this effect, but an implementation is much more complex.

### REFERENCE NUMERALS AND DESIGNATIONS

1 machine
2 bed
3 moveable vise
4 tool unit
5 tool unit
6 tool
7 tool
8 centering drill
9 centering drill
10 machine control
11 Y-support
12 X-support
13 support base
14 pivot pin
15 distance
16a, b tool spindle
17a,b tool spindle
18 Z-support
19 moveable vise table
20 longitudinal direction crank shaft
21 Z-slide
22 X-slide
23 base plate
24 gear rack
25 clamping jaw
26 support
27 threaded spindle
28 spindle nut
29 support block
100 work piece, crank shaft
101 face
102 centering bore hole
103 center support
104 lift bearing
105 pinion
106 flange
107 lobe

1. A method of end machining including introducing a centering bore hole (102) in work pieces (100) with centric rotation symmetrical surfaces, in particular crank shafts (100),
wherein the work piece (100) is clamped
wherein the work piece (100) is cut to length in clamped, stationary condition, and
centering bore holes (102) are introduced into end faces (101) in Z-directions oriented towards one another,
characterized in that
the work piece (100) before introducing the centering bore holes (102) at the latest in clamped condition, is pivoted about an A-axis and/or a B-axis so that the work piece (100) with reference to the common centering axis Z of the centering bore holes (102) has an imbalance that is as small as possible.

2. The method according to claim 1,
characterized in that
the centering bore holes (102) are introduced into two Z-directions of the centering axis (Z) which are aligned with one another and oriented opposite to one another.

3. The method according to one claim 1,
characterized in that
the work piece (100) has a minimized imbalance through pivoting in this condition and/or in a later finished condition.

4. The method according to claim 1,
characterized in that
pivoting is performed in particular about the A-axis through controlled different linear movement of the work piece (100) in particular together with a moveable vise (3) along two Y-guides offset in Z-direction.

5. The method according to claim 1,
characterized in that
pivoting is performed in particular about the A-axis by pivoting about a pivot pin extending in X-direction and moveable in particular in Y-direction.

6. The method according to claim 1,
characterized in that
pivoting in particular about the B-axis is provided through pivoting about a pivot pin extending in Y-direction.

7. The method according to claim 1,
characterized in that
pivoting is achieved in particular about the B-axis through relative adjustment of the tool receivers extending in X-direction, in particular the clamping jaws (25) relative to one another.

8. A machine (1) for end machining including introducing a centering bore hole (102) in work pieces (100) with centric rotation symmetric surfaces, in particular crank shafts (100), comprising:
a bed (2),
a moveable vise (3) for the work piece (100),
tool units (4, 5) arranged at the bed (2) in a linear moveable manner, including tools (6, 7) that are driven to rotate including centering drills (8, 9) oriented in C-direction,
a machine control (10),
characterized in that
the moveable vise (3) is attached at the bed (2) so that it is pivotable about the A-axis,
and/or
either the moveable vise (3) is pivotably arranged at the bed (2) about the B-axis or the clamping jaws (25) extending in X-direction are adjustable relative to one another in X-direction.

9. The machine according to claim 8,
characterized in that
the moveable vise (3) is moveable in Y-direction relative to the bed (2) on Y-guides (11) offset in Z-direction differently on each support and also synchronously on each guide and the tool units (4, 5) are only moveable in Z-direction and in X-direction.

10. The machine according to claim 8,
characterized in that
the moveable vise (3) rests on Y-supports (11) with support bases (13) and the moveable vise (3) is rotatably supported at the support bases (13) and moveably supported in a linear manner at least at one of the support bases (13).

11. The machine according to claim 8,
characterized in that
the moveable vise (3) is moveable in X-direction relative to the bed (2) at least on one X-guide (12).

12. The machine according to claim 8,
characterized in that
the moveable vise (3) is pivotably supported on a pivot pin (14) which extends in X-direction or in Y-direction and which is moveable in particular in the transversal direction oriented perpendicular thereto, thus in the Y-direction or in the X-direction.

13. A method of end machining which comprises:
introducing a centering bore hole (102) in work pieces (100) with centric rotation symmetrical surfaces;
clamping the work piece (100);
cutting the work piece (100) to length in clamped, stationary condition;
introducing centering bore holes (102) into end faces (101) in Z-directions oriented towards one another; and
before introducing the centering bore holes (102), pivoting the work piece (100) about an A-axis or a B-axis so that the work piece (100) with reference to the common centering axis Z of the centering bore holes (102) has a minimum imbalance.
